(19) United States
(12) Patent Application Publication
(10) Pub. No.: US 2005/0013945 A1
(43) Pub. Date: Jan. 20, 2005

(54) Inkjet media with small and large shelled particles

(75) Inventors: Joseph F. Bringley, Rochester, NY (US); Gary N. Barber, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/622,229

(22) Filed: Jul. 18, 2003

(51) Int. Cl. B41M 5/00

(52) U.S. Cl. 428/32.34

(57) ABSTRACT

The invention relates to an image-receiving element comprising a mixture of large and small particles wherein at least one of said large and said small particles is shelled with a material providing image fade resistance.

### FIELD OF THE INVENTION

The present invention relates to an inkjet recording element containing small and large core-shell particles which improve the stability of images applied to the receiver.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water and an organic material such as a monohydric alcohol, a polyhydric alcohol or mixtures thereof.

An inkjet recording element typically comprises a support having on at least one surface thereof an ink-receiving or image-receiving layer, and includes those intended for reflection viewing, which have an opaque support, and those intended for viewing by transmitted light, which have a transparent support.

An important characteristic of inkjet recording elements is their need to dry quickly after printing. To this end, porous recording elements have been developed which provide nearly instantaneous drying as long as they have sufficient thickness and pore volume to effectively contain the liquid ink. For example, a porous recording element can be manufactured by applying a coating of a particulate-containing suspension to a support and then drying.

Another important characteristic of inkjet recording elements is that they should exhibit high gloss so that images printed upon them appear vivid and bright. To this end, the precise size and shape of the particulates are important since it is desirable to achieve both high porosity and high gloss in the coated layer. Large particles (greater than about 500 nm) result in coatings with high porosity but low gloss, whereas small particles (less than about 100 nm) result in low porosity but high gloss.

When a porous recording element is printed with dye-based inks, the dye molecules penetrate the coating layers. However, there is a problem with such porous recording elements in that the optical densities of images printed thereon are lower than one would like. The lower optical densities are believed to be due to optical scatter which occurs when the dye molecules penetrate too far into the porous layer. Another problem with a porous recording element is that atmospheric gases or other pollutant gases readily penetrate the element and lower the optical density of the printed image causing it to fade.

U.S. Pat. No. 6,228,475 B1 to Chu et al. Claims an inkjet recording element comprising a polymeric binder and colloidal silica, wherein all colloidal silica in said image-recording layer consists of colloidal silica having an attached silane coupling agent. The invention is shown to improve the color density and the color retention (or image bleed) of the element after it has been immersed in water. There is a problem, however, in that the invention of Chu et al. does not provide inkjet images with good fade resistance.

U.S. Pat. No. 5,372,884 to Abe et al. discloses an ink-jet recording sheet comprising a support and an ink-receiving layer provided upon at least one side of the support wherein said ink-receiving layer contains a cation modified, nonspherical, colloidal silica obtained by coating the surface of an acicular or fibrous colloidal silica with a cation modifier. There is a problem, however, in that the invention does not provide a recording element with good fade resistance, and furthermore, the gloss of this element is generally lower than that which is desired.

### PROBLEM TO BE SOLVED BY THE INVENTION

There remains a need for inkjct recording elements that, when printed with dye-based inks, provide images which dry very quickly, have high gloss, and have excellent resistance to atmospheric image fade.

### SUMMARY OF THE INVENTION

It is an object of the invention to provide an inkjet recording element that, when printed with dye-based inks, provides images which dry very quickly, has high gloss, and has excellent resistance to atmospheric image fade.

These and other objects of the invention are accomplished by an image-receiving element comprising a mixture of large and small particles wherein at least one of said large and said small particles is shelled with a material providing image fade resistance.

### ADVANTAGEOUS EFFECT OF THE INVENTION

The invention provides an inkjet recording element that, when printed with dye-based inks, provides images which dry very quickly, has high gloss, and has excellent resistance to atmospheric image fade.

### DETAILED DESCRIPTION OF THE INVENTION

The invention has numerous advantages such as providing an ink-jet recording element that, when printed with dye-based inks, provides images which dry very quickly, has high gloss, and has excellent resistance to atmospheric image fade. These and other advantages will be apparent from the detailed description below.

An inkjet image-receiving element may be prepared by solution coating a thin layer, or layers, of materials onto to a support such as paper or plastic. The coated layer may contain numerous materials with the overall functionality of rendering the printed image to the observer. It is generally desired that the image be of high quality and have attributes such as vivid color, high sharpness and clarity, good stain resistance, water permanence and good image fade resistance. Another important attribute of inkjet images is that they dry as quickly as possible. This prevents smearing of images and further improves productivity of a printing system, since images which dry fast can be printed faster. In order for inkjet prints to dry quickly, they must absorb applied ink as rapidly as possible. One method of preparing a rapid-dry image-recording element is to prepare a porous image-receiving layer. The pores of the image-receiving layer draw the applied ink into the receiving layer via a capillary force. Porous image-receiving layers are typically prepared by coating a suspension of particles containing a binder onto a support and allowing the suspension to dry into a thin film. The binder essentially glues the particles to the support, but is coated at a level insufficient to fill the void spaces between the particles. It is these voids that provide the capillary force responsible for drawing the applied ink into the receiver, thus improving the dry time of the element. Generally, it is recognized that larger pores have greater ink capacity, which results in faster drying. Larger pores can be readily generated by controlling the median particle size of the applied particulate suspension; larger particles generally result in larger pore sizes. However, there is a problem with this approach because image-receiving layers prepared from larger particles generally are not as smooth as those prepared from smaller particles, and thus have lower gloss. Gloss is an important attribute of inkjet image-receiving layers since it provides more colorful and vivid images. One method of solving this problem is to form an image-receiving layer from small but highly irregular shaped particles. Irregular shaped particles do not pack as tightly in a coated layer; thus greater void space is created, which results in a greater ink capacity and hence, shorter dry times. This approach, while improved, still does not generally provide images with very high gloss.

Designing inkjet image-receiving layers to have both high porosity and high gloss has led to another problem associated with the stability of ink-jet images. Because the image-receiving layer is porous, gases present in the ambient atmosphere may readily diffuse into the receiver, and oxidizing species such as oxygen and ozone may react chemically with the dye molecules comprising the image, causing the image to bleach or fade. The loss in optical density of a printed image over time due to this and other factors is commonly referred to as image fade. Consequently, it has hitherto been difficult to achieve inkjet recording elements that are simultaneously fast drying and also provide images with high image permanence (the opposite of image fade). The invention herein relates to an inkjet recording element containing small and large core-shell particles, which dries very quickly and provides images having high gloss and excellent resistance to atmospheric image fade.

At least one of the small and large particles which comprise the image-receiving element is “shelled”. The term shelled is used to indicate that the surfaces of the particles have been chemically modified with a composition of matter that is distinctly different from that of the “core”, or interior of the particles. Such surface-modified particles are often referred to as core-shell particles. At least one of the large and small particles present in the image-receiving layer must be shelled with a material providing image fade resistance. It is preferred that both the large and small particles present in the image-receiving layer are shelled with a material providing image fade resistance because such elements have superior image fade resistance. The amount of shell material should be substantially enough to cover all of the surfaces of said small and large particles. It is contemplated that the ratio of shelling material to that of the core particles be from about 1% to about 40% by weight. Preferred shell materials are metal oxide hydroxide complexes having the general formula:
Mⁿ⁺(O)ₐ(OH)_{b}(A^{p-})_{c}.H₂O,
wherein
M is at least one metal ion;
n is 3 or 4;
A is an organic or inorganic ion;
p is 1, 2 or 3; and
x is equal to or greater than 0;
with the proviso that when n is 3, then a, b and c each comprise a rational number as follows: 0≦a<1.5; 0<b<3; and 0≦pc<3, so that the charge of the M³⁺ metal ion is balanced;
and when n is 4, then a, b and c each comprise a rational number as follows: 0≦a<2; 0≦b<4; and 0<pc<4, so that the charge of the M⁴⁺ metal ion is balanced.

Other metal oxide hydroxides suitable for practice of the invention are described in U.S. application Ser. No. 10/180,638, filed Jun. 26, 2002. Metal oxide hydroxide outer layers are preferred because they provide ink jet media with excellent fade resistance.

In another preferred embodiment the shell materials comprise an organosilane or hydrolyzed organosilane having the formula:
Si(OR)ₐZ_{b}
wherein
R is hydrogen, or a substituted or unsubstituted alkyl group having from 1 to about 20 carbon atoms or a substituted or unsubstituted aryl group having from about 6 to about 20 carbon atoms;
Z is an organic group having from 1 to about 20 carbon atoms or aryl group having from about 6 to about 20 carbon atoms, with at least one of said Z's having at least one primary, secondary, tertiary or quaternary nitrogen atom;
a is an integer from 1 to 3; and
b is an integer from 1 to 3;
with the proviso that a+b=4.

Other organosilanes or hydrolyzed organo silanes suitable for practice of the invention are described in Docket No. 84992, Joseph F. Bringley et al., INKJET RECORDING ELEMENT, cofiled herewith. Organosilane or hydrolyzed organosilane outer layers are preferred because they provide ink jet media with excellent fade resistance.

In yet another preferred embodiment the shell material comprises an aluminosilicate polymer having the formula:
AlₓSi_{y}Oₐ(OH)_{b}.nH₂O
where the ratio of x:y is between 1 and 3, and a and b are selected such that the rule of charge neutrality is obeyed; and n is between 0 and 10. Other Aluminosilicate polymers suitable for practice of the invention are described in docket # 85384. Aluminosilicate polymers are preferred because they provide ink jet media with excellent fade resistance.

The small particles of the image-receiving element may be selected from finely-divided particulate materials such as colloidal materials, and latexes. Inorganic materials such as silica, alumina, boehmite, clays, calcium carbonate, barium sulfate, zinc oxide, titania, and zirconia and organic materials such as latexes and polymeric resins are useful for practice of the invention. The median particle size of the small particles should be between about 20 and 180 nm, and it is further preferred that the median particle size should be between about 80 and 140 nm. The preferred particle size ranges provide image-receiving layers with particularly high gloss. The small particles should be substantially homogeneous and have a narrow particle size distribution. That is to say that there should be as few unusually large or unusually small particles as is practically possible. A measurement of the homogeneity of the particles is given by the standard deviation of the particle size distribution. It is preferred that the particle size distribution have a standard deviation of less than 50 nm and more preferably from about 1 to about 25 nm. A small standard deviation indicates a narrow particle size distribution. These ranges are preferred because elements comprising such particles with a narrow distribution generally have smoother surfaces, and hence have higher gloss. It is preferred that the small particles be uniform or symmetrical in shape, and it is further most preferred that the small particles be substantially spherical in shape. Highly symmetrical shapes are preferred because elements comprising such spherical particles generally have smoother surfaces, and hence have higher gloss. In a particularly preferred embodiment of the invention, the small particles comprise colloidal silica. Colloidal silica is preferred because it is a readily available, is relatively inexpensive and may be obtained as uniform, spherically shaped particles.

The large particles of the image-receiving element may be selected from finely-divided particulate materials such as colloidal materials and latexes. Inorganic materials such as silica, alumina, boehmite, clays, calcium carbonate, barium sulfate, zinc oxide, titania, and zirconia and organic materials such as latexes and polymeric resins are useful for practice of the invention. The median particle size of the large particles should be between about 200 and 500 nm, and it is further preferred that the median particle size should be between about 200 and 300 nm. The preferred particle size ranges provide image-receiving layers with greatest porosity. It is preferred that the large particles be substantially irregular in shape. The term irregular is used to describe particles that are neither spherical nor symmetrical in shape. Irregular shaped particles are preferred because they form coated layers with a high percentage of voids and thus have high porosity and short dry times. While irregular in shape, the large particles should be substantially homogeneous and have a narrow particle size distribution. A measurement of the homogeneity of the particles is given by the standard deviation of the particle size distribution. It is preferred that the particle size distribution has a standard deviation of less than 150 nm and more preferably from about 10 to about 100 nm. A small standard deviation indicates a narrow particle size distribution. These ranges are preferred because elements comprising such irregular shaped particles with a narrow particle size distribution generally have high porosity and also have higher gloss than would be obtained with irregular shaped particles having a broader particle size distribution. In a particularly preferred embodiment of the invention, the large particles comprise fumed silica or nonspherically shaped silica. Fumed silica is preferred because it is a readily available, is relatively inexpensive and may be obtained as irregular shaped particles with a narrow particle size distribution.

The large and small particles of the invention may be first dispersed in a suitable medium and coated simultaneously onto a support such as paper or plastic. Alternatively, the large particles may be dispersed and coated and the small particles separately dispersed and coated in an adjacent layer. In a preferred embodiment, the image-receiving layer (or layers) comprise large and small particles, wherein the weight ratio of large to small particles is from 80:20 to 20:80, and more preferably from 65:35 to 35:65. These ratios are preferred because they provide image receiving-layers with both high porosity and high gloss.

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water and an organic material such as a monohydric alcohol, a polyhydric alcohol or mixtures thereof. The ink droplets should be absorbed as quickly as possible by the image-receiving layer. The faster ink is absorbed, the shorter the dry time will be for the element. A short dry time is desired because it prevents smearing of the printed images and increases productivity. The dry time of the imaging element is related to the porosity of the element as the pores of the image-receiving layer draw the applied ink into the element via capillary force. It is preferred that the image-receiving layer has a porosity of greater than about 40%, and it is more preferred that the image-receiving element have a porosity from about 50 to 70% as calculated by the method of Inventive Example 5.

The printed image recorded onto the image-receiving element should appear vivid, colorful and clear. Generally, the perception of color and vividness is related to the gloss of a printed image. It is preferred that the image-receiving element have a 60° gloss of greater than 15, and more preferably greater than 25. These are preferred because it improves the overall image quality of the printed image.

In the practice of the invention, surface modified particles are mixed with a polymeric binder and other materials such as mordants, surfactants, etc., and then coated onto a support to form an image-receiving layer. It is desired that the image-receiving layer is porous and also contains a polymeric binder in a small amount that is insufficient to significantly alter the porosity of the porous receiving layer. Polymers suitable for the practice of the invention are hydrophilic polymers such as poly(vinyl alcohol), poly(vinyl pyrrolidone), gelatin, cellulose ethers, poly(oxazolines), poly(vinylacetamides), partially hydrolyzed poly(vinyl acetate/vinyl alcohol), poly(acrylic acid), poly(acrylamide), poly(alkylene oxide), sulfonated or phosphated polyesters and polystyrenes, casein, zein, albumin, chitin, chitosan, dextran, pectin, collagen derivatives, collodian, agar-agar, arrowroot, guar, carrageenan, tragacanth, xanthan, rhamsan and the like.

In addition to the image-receiving layer, the recording element may also contain a base layer between the support and the image-receiving layer, the function of which is to absorb the solvent from the ink. Materials useful for this layer include dispersed organic and inorganic microparticles, polymeric binder and/or crosslinker.

The support for the inkjet recording element used in the invention can be any of those usually used for inkjet receivers, such as resin-coated paper, paper, polyesters, or microporous materials such as polyethylene polymer-containing material sold by PPG Industries, Inc., Pittsburgh, Pa. under the trade name of Teslin®, Tyvek® synthetic paper (DuPont Corp.), and OPPalyte® films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714, the disclosures of which are hereby incorporated by reference. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyetherimides; and mixtures thereof. The papers listed above include a broad range of papers, from high end papers, such as photographic paper to low end papers, such as newsprint. In a preferred embodiment, polyethylene-coated paper is employed. Polyethylene-coated paper is preferred because of its high smoothness and quality.

The support used in the invention may have a thickness of from about 50 to about 500 μm, preferably from about 75 to 300 μm. This thickness range is preferred because such supports have good structural integrity and are also highly flexible. Antioxidants, antistatic agents, plasticizers and other known additives may be incorporated into the support, if desired.

In order to improve the adhesion of the ink-receiving layer to the support, the surface of the support may be subjected to a corona-discharge treatment prior to applying the image-receiving layer.

Coating compositions employed in the invention may be applied by any number of well-known techniques, including dip-coating, wound-wire rod coating, doctor blade coating, gravure and reverse-roll coating, slide coating, bead coating, extrusion coating, curtain coating and the like. Known coating and drying methods are described in further detail in Research Disclosure no. 308119, published December 1989, pages 1007 to 1008. Slide coating is preferred, in which the base layers and overcoat may be simultaneously applied. Slide coating is preferred because very high quality coatings may be obtained at a low cost using this method. After coating, the layers are generally dried by simple evaporation, which may be accelerated by known techniques such as convection heating.

In order to impart mechanical durability to an inkjet recording element, crosslinkers which act upon the binder discussed above may be added in small quantities. Such an additive improves the cohesive strength of the layer. Crosslinkers such as 1,4-dioxane-2,3-diol, borax, boric acid and its salts, carbodiimides, polyfunctional aziridines, aldehydes, isocyanates, epoxides, polyvalent metal cations, and the like may all be used.

To improve colorant fade, UV absorbers, radical quenchers or antioxidants may also be added to the image-receiving layer as is well known in the art. Other additives include inorganic or organic particles, pH modifiers, adhesion promoters, rheology modifiers, surfactants, biocides, lubricants, dyes, optical brighteners, matte agents, antistatic agents, etc. In order to obtain adequate coatability, additives known to those familiar with such art such as surfactants, defoamers, alcohol and the like may be used. A common level for coating aids is 0.01% to 0.30% active coating aid based on the total solution weight. These coating aids can be nonionic, anionic, cationic or amphoteric. Specific surfactants are described in MCCUTCHEON's Volume 1: Emulsifiers and Detergents, 1995, North American Edition.

The image-receiving layer employed in the invention can contain one or more mordanting species or polymers. The mordant polymer can be a soluble polymer, a charged molecule, or a crosslinked dispersed microparticle. The mordant can be nonionic, cationic or anionic.

The coating composition can be coated either from water or organic solvents; however, water is preferred. The total solids content should be selected to yield a useful coating thickness in the most economical way, and for particulate coating formulations, solids contents from 10%-40% are typical.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543; and 4,781,758, the disclosures of which are hereby incorporated by reference.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir. While the invention is primarily directed to inkjet printing, the recording element could find use in other imaging areas. Other imaging areas include thermal dye transfer printing, lithographic printing, dye sublimation printing, and xerography.

The following examples illustrate the practice of this invention. They are not intended to be exhaustive of all possible variations of the invention. Parts and percentages are by weight unless otherwise indicated.

### EXAMPLES

Measurement of Particle Size and Particle Size Distribution

The volume-weighted median particle sizes of the particles in the silica and core-shell dispersions were measured by a dynamic light scattering method using a MICROTRAC® Ultrafine Particle Analyzer (UPA) Model 150 from Leeds & Northrop. The analysis provides percentile data that show the percentage of the volume of the particles that is smaller than the indicated size. The 50 percentile is known as the median diameter, which is referred herein as median particle size. A measure of the particle size distribution is given by the standard deviation from the median diameter.

Unshelled Colloidal and Fumed Silica

A colloidal dispersion (Nalco® TX11005) of small spherical silica particles was obtained from ONDEO Nalco Chemical Company. The silica particles had a median particle size of 110 nm (with a standard deviation of 20 nm) and a surface area of 26 m²/g, and the dispersion had a pH of about 9.5, a specific gravity of 1.30 g/ml, and a solids content of 41 weight %. A fumed silica dispersion (Cabot CAB-O-SPERSE® PG001) of large irregular shaped silica particles was obtained from Cabot Corporation. The fumed silica particles had a median particle size of 225 nm (with a standard deviation of 90 nm), and the dispersion had a pH of about 10.4, a specific gravity of 1.195 g/ml, and a solids content of 30 weight %.

Preparation of Core-Shell Particles

The hydrolyzable organosilanes used to shell the colloidal and fumed silica was 3-aminopropyltriethoxysilane, which was obtained from Gelest, Inc.

Dispersion A. To 400.0 g of 40.0% Nalco® TX11005, 60.0 g of 1:2 mole ratio mixture of 3-aminopropyltriethoxysilane and acetic acid were added very slowly, while vigorously stirring the mixture. The mixture was allowed to stir for several hours until a homogeneous, nonviscous dispersion was obtained having a pH of 5.10 and a solids content of 42.6%. The median particle size of the core-shell, spherical particles in this dispersion was about 120 nm (with a standard deviation of 20 nm).

Dispersion B. To 200.0 g of 30.0% Cabot CAB-O-SPERSE® PG001, 30.0 g of 1:2 mole ratio mixture of 3-aminopropyltriethoxysilane and acetic acid were added very slowly, while vigorously stirring the mixture. The mixture was allowed to stir for several hours until a homogeneous, nonviscous dispersion was obtained having a pH of 5.10 and a solids content of 32.7%. The median particle size of the core-shell, irregular shaped particles in this dispersion was about 240 nm (with a standard deviation of 100 nm).

Inventive and Comparative Elements

Element 1 (Comparative 1)

An aqueous coating formulation was prepared by combining 80.5 g of 40.0% NALCO® TX11005, 38.5 g of water, 19.1 g of 20.0% Airvol® 203 poly(vinyl alcohol) (Air Products), and 1.8 g of a 10.0% solution of surfactant Zonyl® FSN (E.I. du Pont de Nemours and Co.) to give a coating formulation of 26% solids by weight and a silica/poly(vinyl alcohol)/surfactant ratio of 88.5:10.5:1. A polyethylene-coated paper base, which had been previously coated with a subbing layer of 1.1 g/m² of a 70/30 mixture of Airvol® 203 poly(vinyl alcohol)/borax, was placed on top of a coating block heated at 35° C. A layer of the coating formulation was bead-coated on the subbed support and left on the coating block until dry to yield a recording element in which the thickness of the inkjet receiver layer was about 48 μm and the coverage was about 57 g/m².

Element 2 (Comparative 2)

Element 2 was prepared in the same manner as Element 1 except that the NALCO® TX11005 of the coating formulation was omitted and replaced by a combination of NALCO® TX11005 and Cabot CAB-O-SPERSE® PG001 in a silica weight ratio of 89:11 to yield an element with a silica/poly(vinyl alcohol)/surfactant ratio of 88.5:10.5:1.

Element 3 (Comparative 3)

Element 3 was prepared in the same manner as Element 1 except that the NALCO® TX11005 of the coating formulation was omitted and replaced by a combination of NALCO® TX11005 and Cabot CAB-O-SPERSE® PG001 in a silica weight ratio of 77:23 to yield an element with a silica/poly(vinyl alcohol)/surfactant ratio of 88.5:10.5:1.

Element 4 (Comparative 4)

Element 4 was prepared in the same manner as Element 1 except that the NALCO® TX11005 of the coating formulation was omitted and replaced by a combination of NALCO® TX11005 and Cabot CAB-O-SPERSE® PG001 in a silica weight ratio of 66:34 to yield an element with a silica/poly(vinyl alcohol)/surfactant ratio of 88.5:10.5:1.

Element 5 (Comparative 5)

Element 5 was prepared in the same manner as Element 1 except that the NALCO® TX11005 of the coating formulation was omitted and replaced by a combination of NALCO® TX11005 and Cabot CAB-O-SPERSE® PG001 in a silica weight ratio of 55:45 to yield an element with a silica/poly(vinyl alcohol)/surfactant ratio of 88.5:10.5:1.

Element 6 (Comparative 6)

Element 6 was prepared in the same manner as Element 1 except that the NALCO® TX11005 of the coating formulation was omitted and replaced by a combination of NALCO® TX11005 and Cabot CAB-O-SPERSE® PG001 in a silica weight ratio of 44:56 to yield an element with a silica/poly(vinyl alcohol)/surfactant ratio of 88.5:10.5:1.

Element 7 (Comparative 7)

Element 7 was prepared in the same manner as Element 1 except that the NALCO® TX11005 of the coating formulation was omitted and replaced by a combination of NALCO® TX11005 and Cabot CAB-O-SPERSE® PG001 in a silica weight ratio of 32:68 to yield an element with a silica/poly(vinyl alcohol)/surfactant ratio of 88.5:10.5:1.

Element 8 (Comparative 8)

Element 8 was prepared in the same manner as Element 1 except that the NALCO® TX11005 of the coating formulation was omitted and replaced by core-shell silica Dispersion A to yield an element with a core-shell silica/poly(vinyl alcohol)/surfactant ratio of 88.5:10.5:1.

Element 9 (Comparative 9)

Element 9 was prepared in the same manner as Element 1 except that the NALCO® TX11005 of the coating formulation was omitted and replaced by a combination of core-shell silica Dispersion A and core-shell silica Dispersion B in a silica weight ratio of 89:11 to yield an element with a core-shell silica/poly(vinyl alcohol)/surfactant ratio of 88.5:10.5:1.

Element 10 (Inventive 1)

Element 10 was prepared in the same manner as Element 1 except that the NALCO® TX11005 of the coating formulation was omitted and replaced by a combination of core-shell silica Dispersion A and core-shell silica Dispersion B in a silica weight ratio of 77:23 to yield an element with a core-shell silica/poly(vinyl alcohol)/surfactant ratio of 88.5:10.5:1.

Element 11 (Inventive 2)

Element 11 was prepared in the same manner as Element 1 except that the NALCO® TX11005 of the coating formulation was omitted and replaced by a combination of core-shell silica Dispersion A and core-shell silica Dispersion B in a silica weight ratio of 66:34 to yield an element with a core-shell silica/poly(vinyl alcohol)/surfactant ratio of 88.5:10.5:1.

Element 12 (Inventive 3)

Element 12 was prepared in the same manner as Element 1 except that the NALCO® TX11005 of the coating formulation was omitted and replaced by a combination of core-shell silica Dispersion A and core-shell silica Dispersion B in a silica weight ratio of 55:45 to yield an element with a core-shell silica/poly(vinyl alcohol)/surfactant ratio of 88.5:10.5:1.

Element 13 (Inventive 4)

Element 13 was prepared in the same manner as Element 1 except that the NALCO® TX11005 of the coating formulation was omitted and replaced by a combination of core-shell silica Dispersion A and core-shell silica Dispersion B in a silica weight ratio of 44:56 to yield an element with a core-shell silica/poly(vinyl alcohol)/surfactant ratio of 88.5:10.5:1.

Element 14 (Inventive 5)

Element 14 was prepared in the same manner as Element 1 except that the NALCO® TX11005 of the coating formulation was omitted and replaced by a combination of core-shell silica Dispersion A and core-shell silica Dispersion B in a silica weight ratio of 32:68 to yield an element with a core-shell silica/poly(vinyl alcohol)/surfactant ratio of 88.5:10.5:1.

Each of the elements was printed using an Epson Stylus® Photo 870 inkjet printer using inks with catalogue numbers CT13T007201 and C13T008201. The cyan and magenta inks were printed in 6 steps of increasing density, and the optical density of each step was read using a GretagMacbeth™ Spectrolino/SpectroScan. The samples were then placed together in a controlled atmosphere of 5 parts per million ozone concentration, and the densities at each step reread after 12 hours. The percent density loss at a starting density of 1.0 was interpolated for the cyan and magenta dyes. The porosity of each element was calculated from coating weight and thickness data; the percent porosity taken as the difference between the calculated volume and the theoretical volume, divided by the calculated volume. The gloss of each element was also analyzed at a 60° angle using a BYK-Gardner® micro-TR1-gloss meter. The results are summarized in Table 1.

TABLE 1

| | | | | Per- | | | Per- |
|---|---|---|---|---|---|---|---|
| | Percent | Percent | | cent | 60° | Percent | cent |
| Exam- | Small | Large | | Poro- | Gloss | Magenta | Cyan |
| ple | Particles | Particles | Shell | sity | (%) | Fade | Fade |
| C-1 | 100 | 0 | None | 42 | 40 | 40 | 11 |
| C-2 | 89 | 11 | None | 45 | 31 | 48 | 40 |
| C-3 | 77 | 23 | None | 48 | 29 | 26 | 50 |
| C-4 | 66 | 34 | None | 52 | 12 | 28 | 50 |
| C-5 | 55 | 45 | None | 55 | 6 | 19 | 47 |
| C-6 | 44 | 56 | None | 60 | 5 | 17 | 60 |
| C-7 | 32 | 68 | None | 65 | 9 | 12 | 54 |
| C-8 | 100 | 0 | Yes | 33 | 4 | 3 | 0 |
| C-9 | 89 | 11 | Yes | 37 | 7 | 0 | 0 |
| I-1 | 77 | 23 | Yes | 42 | 16 | 0 | 6 |
| I-2 | 66 | 34 | Yes | 39 | 29 | 1 | 18 |
| I-3 | 55 | 45 | Yes | 48 | 29 | 2 | 15 |
| I-4 | 44 | 56 | Yes | 52 | 33 | 4 | 25 |
| I-5 | 32 | 68 | Yes | 58 | 31 | 4 | 11 |

The above results demonstrate the advantages of the invention. By analysis of the data for the comparative examples, it is seen that the porosity in the comparative elements is increased as the percentage of large silica particles is increased; however, that trend in porosity improvement is accompanied by a substantial reduction in gloss. Furthermore, none of the comparative examples exhibit a desirable combination of high gloss, high porosity and low ozone-induced fade of the cyan and magenta dyes. Analysis of the inventive examples indicates that these elements have surprisingly high porosity and high gloss even for elements having a relatively high percentage of large silica particles. Furthermore, these elements exhibit improved magenta and cyan dye ozone-induced fade relative to the corresponding comparative examples.

The invention has been described in detail with particular reference to certain preferred embodiments thereof, but it will be understood that variations and modifications can be effected within the spirit and scope of the invention.

1. An image-receiving element comprising a mixture of large and small particles wherein at least one of said large and said small particles is shelled with a material providing image fade resistance.

2. The image-receiving element of claim 1 wherein both said large particles and said small particles are shelled with a material providing image fade resistance.

3. The image-receiving element of claim 1 wherein said small particles have a median particle size of between 80 and 140 nm.

4. The image-receiving element of claim 1 wherein said small particles have a median particle size of between 20 and 180 nm.

5. The image-receiving element of claim 1 wherein said large particles have a median particle size of between 200 and 500 mm.

6. The image-receiving element of claim 1 wherein said large particles have a median particle size of between 200 and 300 nm.

7. The image-receiving element of claim 1 wherein said large particles and said small particles have a ratio of from 80:20 to 20:80.

8. The image-receiving element of claim 1 wherein said large particles and said small particles have a ratio of from 65:35 to 35:65.

9. The image-receiving element of claim 1 wherein said element has a porosity of greater than about 40%.

10. The image-receiving element of claim 1 wherein said element has a porosity from about 50 to 70%.

11. The image-receiving element of claim 1 wherein said element has a 60° gloss of greater than 15.

12. The image-receiving element of claim 1 wherein said element has a 60° gloss of greater than 25.

13. The image-receiving element of claim 1 wherein said small particles have a particle size distribution with a standard deviation of less than 50 nm.

14. The image-receiving element of claim 1 wherein said small particles have a particle size distribution with a standard deviation of between 1 and 25 nm.

15. The image-receiving element of claim 1 wherein said large particles have a particle size distribution with a standard deviation of less than 150 nm

16. The image-receiving element of claim 1 wherein said large particles have a particle size distribution with a standard deviation of between 10 and 100 nm.

17. The image-receiving element of claim 1 wherein said large particles comprise fumed silica.

18. The image-receiving element of claim 1 wherein said large particles have an irregular shape.

19. The image-receiving element of claim 1 wherein said small particles comprise colloidal silica.

20. The image-receiving element of claim 1 wherein said small particles are generally spherical.

21. The image-receiving element of claim 1 wherein said small particles are generally symmetrical.

22. The image-receiving element of claim 1 wherein said material providing fade resistance comprises hydrolyzable organosilanes.

23. The image-receiving element of claim 1 wherein said material providing fade resistance comprises aluminasilicate polymers.

24. The image-receiving element of claim 1 wherein said material providing fade resistance comprises metal oxyhydroxy complexes.
